(19) United States
(12) Patent Application Publication
(10) Pub. No.: US 2008/0120667 A1
(43) Pub. Date: May 22, 2008

(54) HYBRID MPEG/IP DIGITAL CABLE GATEWAY DEVICE AND ARCHITECTURE ASSOCIATED THEREWITH

(75) Inventor: Etai Zaltsman, Ramat Hasharon (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/927,179

(22) Filed: Oct. 29, 2007

Related U.S. Application Data
(60) Provisional application No. 60/866,299, filed on Nov. 17, 2006.

(51) Int. Cl. H04N 7/173; H04L 12/66; H04L 12/56

(52) U.S. Cl. 725/110; 370/401

(57) ABSTRACT

A novel cable gateway system and architecture incorporating a hybrid digital video transceiver. The digital cable system architecture combines reception of legacy video such as MPEG-TS based DVB-C streams with that of original IP video over DOCSIS channels. The system comprises a hybrid DVB/IP cable gateway STB capable of receiving both legacy DVB-C video and original IP video streams. The cable gateway device performs the front-end functionality (including QAM receiver, tuner and broadband connection) while the back-end functionality of video decoding and display is performed by one or more standard IP-STBs connected to the cable gateway device over a network (e.g., home LAN). Legacy MPEG-TS based DVB-C video is captured and encapsulated into packets for distribution over the network to the IP-STBs. The cable gateway distributes the original IP video received over the CATV source and the encapsulated legacy video as video over IP packets over the network.

### REFERENCE TO PRIORITY APPLICATION

This application claims priority to U.S. Provisional Application Ser. No. 60/866,299, filed Nov. 17, 2006, entitled “Hybrid Digital Video Transceiver and method of Using Same”, incorporated herein by reference in its entirety.

### FIELD OF THE INVENTION

The present invention relates to the field of digital video and more particularly relates to a cable gateway system and architecture incorporating a hybrid digital video transceiver.

### BACKGROUND OF THE INVENTION

Currently there are more than 50 million high-speed Internet access customers in North America. Recently, the cable modem has become the broadband connection of choice for many Internet users, being preferred over the nearest rival broadband technology, Digital Subscriber Line (DSL), by a significant margin.

Cable modems are well known in the art. A cable modem is a type of modem that provides access to a data signal sent over the cable television (CATV) infrastructure. Cable modems are primarily used to deliver broadband Internet access, taking advantage of unused bandwidth on a cable television network. In 2005 there were over 22.5 million cable modem users in the United States alone.

A cable modem is a network appliance that enables high speed data connections to the internet via data services provided by the local cable company. Data from the home is sent upstream on a carrier that operates on the 5 MHz to 42 MHz band of the cable spectrum. Downstream data is carried on a 88 MHz to 860 MHz band. The cable modem system can have additional networking features such as Voice over IP (VoIP), wireless connectivity or network switch or hub functionality.

The term cable Internet access refers to the delivery of Internet service over the cable television infrastructure. The proliferation of cable modems, along with DSL technology, has enabled broadband Internet access in many countries. The bandwidth of cable modem service typically ranges from 3 Mbps up to 40 Mbps or more. The upstream bandwidth on residential cable modem service usually ranges from 384 kbps to 30 Mbps or more. In comparison, DSL tends to offer less speed and more variance between service packages and prices. Service quality is also far more dependent on the client's location in relation to the telephone company's nearest central office or Remote Terminal.

Users in a neighborhood share the available bandwidth provided by a single coaxial cable line. Therefore, connection speed varies depending on how many people are using the service at the same time. In most areas this has been eliminated due to redundancy and fiber networks.

With the advent of Voice over IP telephony, cable modems are also being used to provide telephone service. Many people who have cable modems have opted to eliminate their Plain Old Telephone Service (POTS). An alternative to cable modems is the Embedded Multimedia Terminal Adapter (EMTA). An EMTA allows multiple service operators (MSOs) to offer both High Speed Internet and VoIP through a single piece of customer premise equipment. A multiple system operator is an operator of multiple cable television systems.

Many cable companies have launched Voice over Internet Protocol (VoIP) phone service, or digital phone service, providing consumers a true alternative to standard telephone service. Digital phone service takes the analog audio signals and converts them to digital data that can be transmitted over the fiber optic network of the cable company. Cable digital phone service is currently available to the majority of U.S. homes with a large number of homes are now subscribing. The number of homes subscribing is currently growing by hundreds of thousands each quarter. One significant benefit of digital phone service is the substantial consumer savings, with one recent study saying residential cable telephone consumers could save an average of $135 or more each year.

The Data Over Cable Service Interface Specification (DOCSIS) compliant cable modems have been fueling the transition of cable television operators from a traditional core business of entertainment programming to a position as full-service providers of video, voice, and data telecommunications services.

Cable systems transmit digital data signals over radio frequency (RF) carrier signals. To provide two-way communication, one carrier signal carries data in the downstream direction from the cable network to the customer and another carrier signal carries data in the upstream direction from the customer to the cable network. Cable modems are devices located at the subscriber premises that functions to convert digital information into a modulated RF signal in the upstream direction, and to convert the RF signals to digital information in the downstream direction. A cable modem termination system (CMTS) performs the opposite operation for multiple subscribers at the cable operator's head-end.

Typically, several hundreds of users share a 6 MHz downstream channel and one or more upstream channels. The downstream channel occupies the space of a single television transmission channel in the cable operator's channel lineup. It is compatible with digital set top MPEG transport stream modulation (64 or 256 QAM), and provides up to 40 Mbps. A media access control (MAC) layer coordinates shared access to the upstream bandwidth.

The latest DOCSIS specification, DOCSIS 3.0, include a number of enhancements. In order to provide faster data rates to customers, DOCSIS 3.0 introduces the concept of bonding several physical downstream channels into one virtual high speed pipe. Channel bonding is a load-sharing technique for logically combining multiple DOCSIS channels. DOCSIS 3.0 defines channel bonding for both the upstream and downstream directions. For downstream channel bonding, each downstream DOCSIS channel carries a payload of approximately 38 Mbps (50 Mbps with EuroDOCSIS). Load sharing traffic across multiple channels allows a maximum throughput of up to n×38 Mbps (or n×50 Mbps), with n representing the number of channels being bonded. A separate 6 MHz or 8 MHz frequency is used for each of the bonded channels. Upstream channel bonding is possible for a minimum of four channels, 10 to 30 Mbps each, for a total of 40 to 120 Mbps of shared throughput.

Cable modems and DOCSIS standard have made delivery of digital services over hybrid fiber coaxial (HFC) cable television systems possible. Digital data delivery of Internet data, video on demand movies, telephony, telephony over the Internet, interactive games, upstream delivery of security camera digital photos to security services and a host of other applications is now possible. These services and applications are useful and valuable with some requiring more bandwidth than others. Video and movies, for example, even when compressed using MPEG standards, require large amounts of bandwidth.

The DOCSIS 3.0 specification also enables enhanced video applications that are much improved over earlier versions of the specification. The new video applications enable simultaneous multiple video channel reception. These new video applications, however, require channel flexibility, especially in connection with the tuner circuit in the receiver portion of the cable modem. Depending on the particular video application and user settings, channels may be located anywhere in the downstream (DS) frequency band, thus requiring full band capture. Thus, the capture bandwidth (CBW) may be located anywhere in the downstream frequency band at any instant in time wherein the capture bandwidth can range from 60 to 100 MHz. The tuner must be able to receive these multiple video channels in order to meet the requirements of the specification. Moreover, practical HFC plants constraints will force MSOs to locate new video services outside the current DOCSIS 3.0 CBW limitations.

Currently, cable set top boxes (STBs) are becoming key devices in home entertainment networks, not only to receive digital television (DTV), but also as residential gateways to deliver multiple services. To gain in flexibility and modularity in home networks, the functionality of STBs may be distributed between a main device and several peripherals connected by a network. The main device works as a gateway between cable, terrestrial or satellite DTV distribution systems and the home network. The peripheral devices are decoders placed close to each TV set and are called IP-STBs.

A block diagram illustrating an example prior art digital cable set top box (STB) is shown in FIG. 1. The digital cable STB, generally referenced 10, comprises one or more tuners 12 coupled to an input CATV signal source 11, Quadrature Amplitude Modulation (QAM) receivers 14 generating MPEG signals 16, conditional access system (CAS) module 18 for decoding premium programming, DOCSIS MAC 20 including the control channel to create a two way signaling channel for interactive services, MPEG decoder 24 and video display module (i.e. video processor) 26 that has an MPEG-TS connection to the QAM receivers for the DVB stream for generating the video out signal 28 for display on a end user's television set (TV).

A conventional cable set top box (STB) comprises a digital Motion Picture Experts Group/Digital Video Broadcasting-Cable (MPEG/DVB-C) transceiver that is able to decode and display programs that are transmitted digitally over a 6 or 8 MHz channel in the form of a Motion Picture Experts Group-Transport Stream (MPEG-TS) video stream. The STB consists of a QAM receiver 14 that functions to convert the signal into a stream of MPEG frames 16, a Conditional Access System (CAS) 18 that negotiates security keys for encrypted content, an MPEG decoder 24 which decodes the compressed video stream and display elements 26 that sends the decoded picture to the TV.

Advanced STBs, referred to as Personal Video Recorders (PVRs), further include a hard drive (HDD) for storing content and watching them some point later in time. The STB comprises multiple receivers for handling more than one video stream at a time. This can be used, for example, to display one program and record another one simultaneously, for picture in picture (PIP) functions, etc.

An STB referred to as an IP-STB, functions to receive a stream of IP packets that carries the video information. The IP STB is fast becoming the entertainment epicenter of the digital home since it can be used by both cable operators and Telco's that are able to deliver video over IP. The interface to this box is some sort of a network connection (e.g., Ethernet).

A problem arises, however, in that Multi-Service Operators (MSOs) (i.e. cable service providers) would like to continue transmitting legacy channels as MPEG-TS in order not to replace existing STBs already deployed. They would, however, also like to transmit new content over Internet Protocol (IP) utilizing a broadband connection, typically a DOCSIS cable modem.

A limitation of the architecture of prior art STBs is the coupling of the front-end (i.e. the QAM receiver, tuner and broadband connection) with the video decoding and display components. In homes with more than one TV (which is the majority of homes today), the entire STB needs to be duplicated. In homes with large numbers of TVs (3, 4, 5 or more) every TV needs a corresponding set top box. This is very inefficient in terms of cost and space.

There is thus a need for a digital cable system architecture that combines reception of legacy video with that of original IP video. The system should be capable of receiving both legacy DVB-C video and original IP video streams in a hybrid DVB/IP STB which decouples the front-end functionality from that of the video decoding and display components. The system should operate efficiently, exhibit high performance, consume minimal board and chip area and be able to be manufactured at low cost.

### SUMMARY OF THE INVENTION

The present invention is a novel cable gateway system and architecture incorporating a hybrid digital video transceiver. The digital cable system architecture combines reception of legacy video such as MPEG-TS based DVB-C streams with that of original IP video over DOCSIS channels. The system comprises a hybrid DVB/IP cable gateway STB capable of receiving both legacy DVB-C video and original IP video streams. The invention is operative to decouple the front-end functionality of prior art STBs from that of the video decoding and display components.

The cable gateway device performs the front-end functionality (including QAM receiver, tuner and broadband connection) while the back-end functionality of video decoding and display is performed by one or more standard IP-STBs connected to the cable gateway device over a network (e.g., home LAN).

In order to provide legacy video to IP-STBs, the cable gateway of the present invention captures the legacy MPEG-TS based DVB-C video and encapsulates it into packets (i.e. IP packets) for distribution over the network (e.g., Ethernet LAN) to the IP-STBs. The cable gateway distributes the original IP video received over the CATV source and the encapsulated legacy video as video over IP packets over the network.

Embodiments of the invention provide a single chip DOCSIS 3.0 modem, incorporating multiple QAM receivers and advanced DOCSIS MAC, that enable the ability to assign each of the QAM receivers to (1) a DOCSIS bonding group, (2) a legacy video channel or (3) a combination of both if the DOCSIS and MPEG video are multiplexed on the same channel.

Another embodiment provides a method to receive legacy MPEG-TS video streams and encapsulate it into IP packets for distribution to an IP-STB over a network. A further embodiment includes the architecture of a centralized cable gateway device and separate IP set-top boxes connected over a network. The IP-STBs are capable of seamlessly decoding original IP video as well as DVB-C type of video that was converted into IP video by the cable gateway device. Further, the invention provides a method of terminating the Conditional Access (CA) at the cable gateway device utilizing Digital Rights Management (DRM) techniques thereby eliminating the inefficient and wasteful requirement that each IP-STB terminate the CA individually.

Advantages of the architecture of the present invention include (1) efficiency in that if the user has many TVs, the front-end portion of receiving, decoding, etc. does not need to be duplicated for each STB as only a single instance is required; and (2) lower cost in that the IP-STB is fast becoming standard and the cable gateway is the only element in the system that is network specific.

To aid in understanding the principles of the present invention, the description is provided in the context of a DOCSIS 3.0 capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which cab benefit from a multi-tuner integrated circuit chip.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a cable gateway system comprising a cable gateway device comprising first receive means for receiving a legacy Digital Video Broadcasting-Cable (DVB-C) video stream from a CATV signal source, second receive means for receiving original Internet Protocol (IP) video from the CATV source, encapsulation means for encapsulating the legacy DVB-C video for transmission over a network, distribution means for transmitting the original IP video and the encapsulated legacy video over the network as a video over IP stream and one or more IP set top boxes (STBs) connected to the network, each set top box comprising third receive means for receiving and decoding both the original IP video and the encapsulated legacy video for viewing on a video display connected thereto.

There is also provided in accordance with the invention, a method of video distribution, the method comprising the steps of receiving legacy Digital Video Broadcasting-Cable (DVB-C) video from a CATV signal source, encapsulating the legacy video into a plurality of packets for transmission over a network, receiving an original Internet Protocol (IP) video stream over the CATV source and distributing the legacy video packets and the original IP video as a video over IP stream over the network to one or more IP set top boxes connected thereto.

There is further provided in accordance with the invention, a cable gateway device coupled to a network comprising a plurality of receivers, each the receiver operative to receive legacy Motion Picture Experts Group-Transport Stream (MPEG-TS) based Digital Video Broadcasting-Cable (DVB-C) video channels and original Internet Protocol (IP) video over Data Over Cable Service Interface Specification (DOCSIS) channels, means for encapsulating the legacy video into IP packets and a transmitter operative to transmit the original DOCSIS IP video channels and the MPEG-TS legacy video as a video over IP stream to one or more IP set top boxes (STBs) connected to the network.

There is also provided in accordance with the invention, a cable gateway connected to a CATV signal source and a local area network (LAN) comprising first means for receiving legacy Motion Picture Experts Group-Transport Stream (MPEG-TS) based Digital Video Broadcasting-Cable (DVB-C) video from the CATV signal source, second means for receiving original Internet Protocol (IP) video Data Over Cable Service Interface Specification (DOCSIS) channels, means for encapsulating the legacy video and means for distributing the original IP video and the encapsulated legacy video as a video over IP stream to one or more IP set top boxes connected to the network.

There is further provided in accordance with the invention, a cable gateway connected to a network comprising a plurality of tuners, each adapted to receive a CATV signal source, a plurality of receivers, each receiver associated with one of the tuners and operative to receive legacy Motion Picture Experts Group-Transport Stream (MPEG-TS) based Digital Video Broadcasting-Cable (DVB-C) video channels and original Internet Protocol (IP) video over Data Over Cable Service Interface Specification (DOCSIS) channels, a DOCSIS cable modem, the cable modem comprising means for capturing and encapsulating the legacy MPEG-TS video into IP packets for distribution to one or more IP set top boxes (STBs), a DOCSIS media access control (MAC) operative to receive the DOCSIS MPEG frames and to generate an IP video stream therefrom, distribution means for transmitting the legacy MPEG-TS video IP packets and the IP video stream as an IP over video stream to the one or more IP-STBs over the network.

### BRIEF DESCRIPTION OF THE DRAWINGS

The invention is herein described, by way of example only, with reference to the accompanying drawings, wherein:

FIG. 1 is a block diagram illustrating an example prior art digital cable set top box;

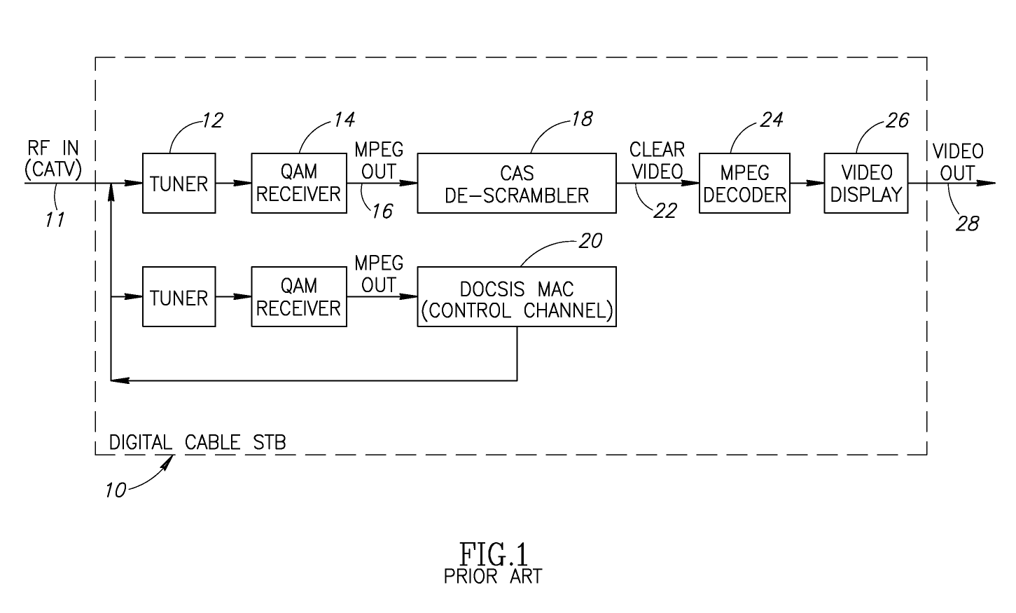

FIG. 2 is a block diagram illustrating an example cable modem system incorporating the cable gateway and IP set top box architecture of the present invention;

FIG. 3 is a block diagram illustrating an example home network incorporating the cable gateway architecture of the present invention;

FIG. 4 is a diagram illustrating the structure of the MPEG-2 transport stream (TS) in more detail;

FIG. 5 is a diagram illustrating the structure of an MPEG-TS frame in more detail;

FIG. 6 is a simplified block diagram illustrating the cable gateway device of the present invention;

FIG. 7 is a block diagram illustrating an example cable gateway of the present invention;

FIG. 8 is a diagram illustrating the capture bandwidth of the downstream band received from the CMTS;

FIG. 9 is a simplified block diagram illustrating the DOCSIS processing portion of the cable gateway of FIG. 7 in more detail; and

FIG. 10 is a block diagram illustrating the IP set top box of the present invention in more detail.

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| ASIC | Application Specific Integrated Circuit |
| ATM | Asynchronous Transfer Mode |
| CA | Conditional Access |
| CAS | Conditional Access System |
| CATV | Community Antenna Television or Cable TV |
| CBW | Capture Bandwidth |
| CBW | Capture Bandwidth |
| CM | Cable Modem |
| CMTS | Cable Modem Termination System |
| CO | Central Office |
| CPU | Central Processing Unit |
| DAC | Digital to Analog Converter |
| DC | Direct Current |
| DCAS | Downloadable Conditional Access Systems |
| DECT | Digital Enhanced Cordless Telecommunications |
| DHCP | Dynamic Host Control Protocol |
| DOCSIS | Data Over Cable Service Interface Specification |
| DRM | Digital Rights Management |
| DS | Downstream |
| DSL | Digital Subscriber Line |
| DSP | Digital Signal Processor |
| DVB-C | Digital Video Broadcasting-Cable |
| DVR | Digital Video Recorder |
| EEROM | Electrically Erasable Read Only Memory |
| EMTA | Embedded Multimedia Terminal Adapter |
| FPGA | Field Programmable Gate Array |
| GPIO | General Purpose I/O |
| HDD | Hard Disk Drive |
| HDL | Hardware Description Language |
| HFC | Hybrid Fiber Coaxial |
| HPNA | Home Phoneline Networking Association |
| IC | Integrated Circuit |
| IP | Internet Protocol |
| LAN | Local Area Network |
| LED | Light Emitting Diode |
| LNA | Low Noise Amplifier |
| MAC | Media Access Control |
| MoCA | Multimedia over Coax Alliance |
| MPEG | Moving Picture Experts Group |
| MPEG-TS | Moving Picture Experts Group-Transport Stream |
| MSO | Multiple Service Operator |
| NIC | Network Interface Card |
| OTG | On-the Go |
| PC | Personal Computer |
| PDA | Personal Digital Assistant |
| PDU | Protocol Data Unit |
| PGA | Programmable Gain Amplifier |
| PIP | Picture-in-Picture |
| POTS | Plain Old Telephone Service |
| PSTN | Public Switched Telephone Network |
| PVR | Personal Video Recorder |
| QAM | Quadrature Amplitude Modulation |
| RAM | Random Access Memory |
| RF | Radio Frequency |
| ROM | Read Only Memory |
| RTP | Real-time Protocol |
| SLIC | Subscriber Line Interface Card |
| SONET | Synchronous Optical Network |
| STB | Set Top Box |
| TB | Tuning Band |
| TV | Television |
| UDP | User Datagram |
| US | Upstream |
| USB | Universal Serial Bus |
| VoIP | Voice over IP |
| WAN | Wide Area Network |
| WLAN | Wireless Local Area Network |

### Detailed Description of the Invention

The present invention is a novel cable gateway system and architecture incorporating a hybrid digital video transceiver. The digital cable system architecture combines reception of legacy video such as MPEG-TS based DVB-C streams with that of original IP video over DOCSIS channels. The system comprises a hybrid DVB/IP cable gateway STB capable of receiving both legacy DVB-C video and original IP video streams. The invention is operative to decouple the front-end functionality of prior art STBs from that of the video decoding and display components.

To aid in understanding the principles of the present invention, the description is provided in the context of a DOCSIS 3.0 capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which cab benefit from a multi-tuner integrated circuit chip.

Note that throughout this document, the term communications device is defined as any apparatus or mechanism adapted to transmit, or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof.

The term cable modem is defined as a modem that provides access to a data signal sent over the cable television infrastructure. The term voice cable modem is defined as a cable modem that incorporates VoIP capabilities to provide telephone services to subscribers. Channel bonding is defined as a load-sharing technique for logically combining multiple DOCSIS channels into a single virtual pipe. It is described in detail in the DOCSIS 3.0 specification, incorporated herein by reference in its entirety.

### Cable System Incorporating Cable Gateway Architecture

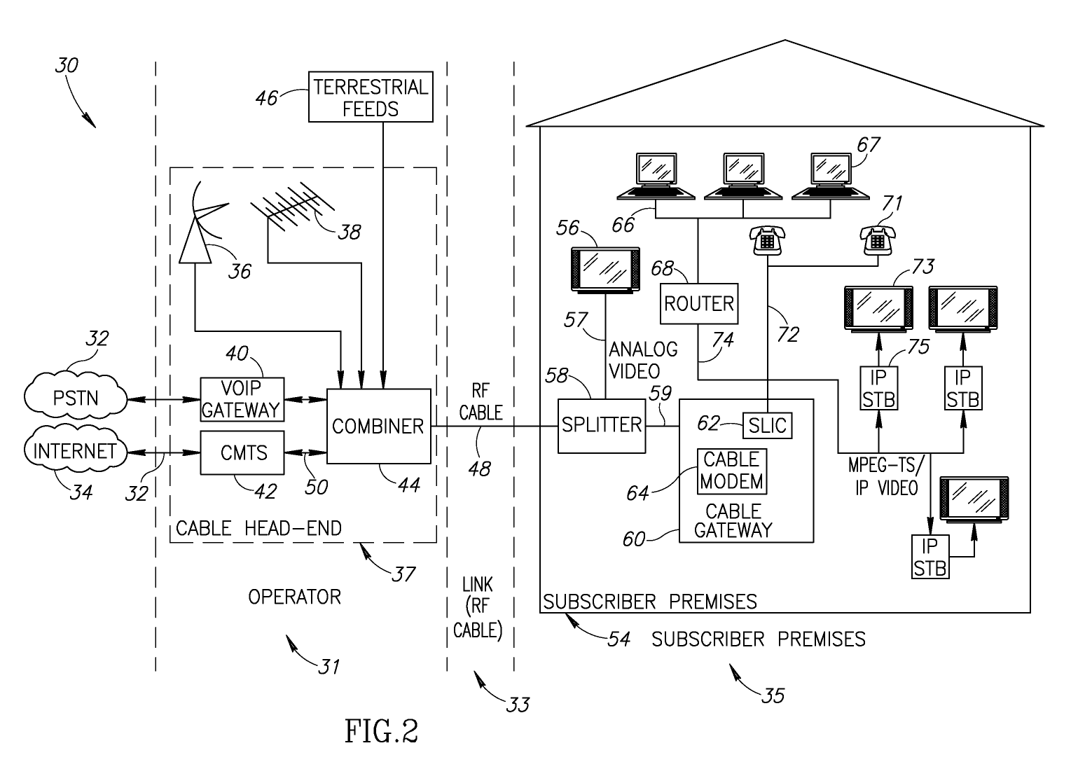

A block diagram illustrating a cable modem system incorporating the cable gateway and IP set top box architecture of the present invention is shown in FIG. 2. The system, generally referenced 30, comprises an operator portion 31 connected to the public switched telephone network (PSTN) 32 and the Internet 34 or other wide area network (WAN), a link portion 33 comprising the RF cable 48 and a subscriber portion 35 comprising the subscriber premises 54.

The operator portion 31 comprises the cable head-end 37 which is adapted to receive a number of content feeds such as satellite 36, local antenna 38 and terrestrial feeds 46, all of which are input to the combiner 44. The cable head-end also comprises the voice over IP (VoIP) gateway 40 and Cable Modem Termination System (CMTS) 42. The combiner merges the TV programming feeds with the RF data from the CMTS.

The Cable Modem Termination System (CMTS) is a computerized device that enables cable modems to send and receive packets over the Internet. The IP packets are typically sent over Layer 2 and may comprise, for example, Ethernet or SONET frames or ATM cells. It inserts IP packets from the Internet into MPEG frames and transmits them to the cable modems in subscriber premises via an RF signal. It does the reverse process coming from the cable modems. A DOCSIS-compliant CMTS enables customer PCs to dynamically obtain IP addresses by acting as a proxy and forwarding DHCP requests to DHCP servers. A CMTS may provide filtering to protect against theft of service and denial of service attacks or against hackers trying to break into the cable operator's system. It may also provide traffic shaping to guarantee a specified quality of service (QoS) to selected customers. A CMTS may also provide bridging or routing capabilities.

The subscriber premises 54 comprises a splitter 58, cable appliances 56 such as televisions, DVRs, etc., cable gateway device 60, a plurality of IP set top boxes (STBs) 75 coupled to televisions 73, router 68, PCs or other networked computing devices 67 and telephone devices 71. Cable service is provided by the local cable provider wherein the cable signal originates at the cable head end facility 37 and is transmitted over RF cable 48 to the subscriber premises 54 where it enters splitter 58. One output 57 of the splitter goes to analog televisions to display analog video.

The other output 59 of the splitter comprises the data portion of the signal which is input to the cable gateway 60. The cable gateway is adapted to provide both Ethernet and USB ports. Typically, a router 68 is connected to the Ethernet port via Ethernet cable 74. One or more network capable computing devices 67, e.g., laptops, PDAs, desktops, etc. are connected to the router 68 via internal Ethernet network wiring 66. In addition, the router may comprise or be connected to a wireless access point that provides a wireless network (e.g., 802.11b/g/a) throughout the subscriber premises.

The cable modem also comprises a subscriber line interface card (SLIC) 62 which provides the call signaling and functions of a conventional local loop to the plurality of installed telephone devices 71 via internal 2-wire telephone wiring 72. In particular, it generates call progress tones including dial tone, ring tone, busy signals, etc. that are normally provided by the local loop from the CO. Since the telephone deices 71 are not connected to the CO, the SLIC in the cable modem must provide these signals in order that the telephone devices operate correctly.

The cable modem also comprises the cable gateway device 60 of the present invention. The gateway comprises a DOCSIS compatible cable modem for receiving both legacy MPEG-TS based DVB-C video and original IP video over DOCSIS channels. In accordance with the invention, MPEG-TS streams are encapsulated and transmitted over the network (i.e. Ethernet LAN) 74 from the cable gateway to individual IP set top boxes 75. Each IP set top box, in turn, is connected to a television. A digital video output signal is displayed to the user (i.e. cable subscribers) via one of the televisions 73 (i.e. video display device or other cable appliance).

### Cable Gateway Architecture

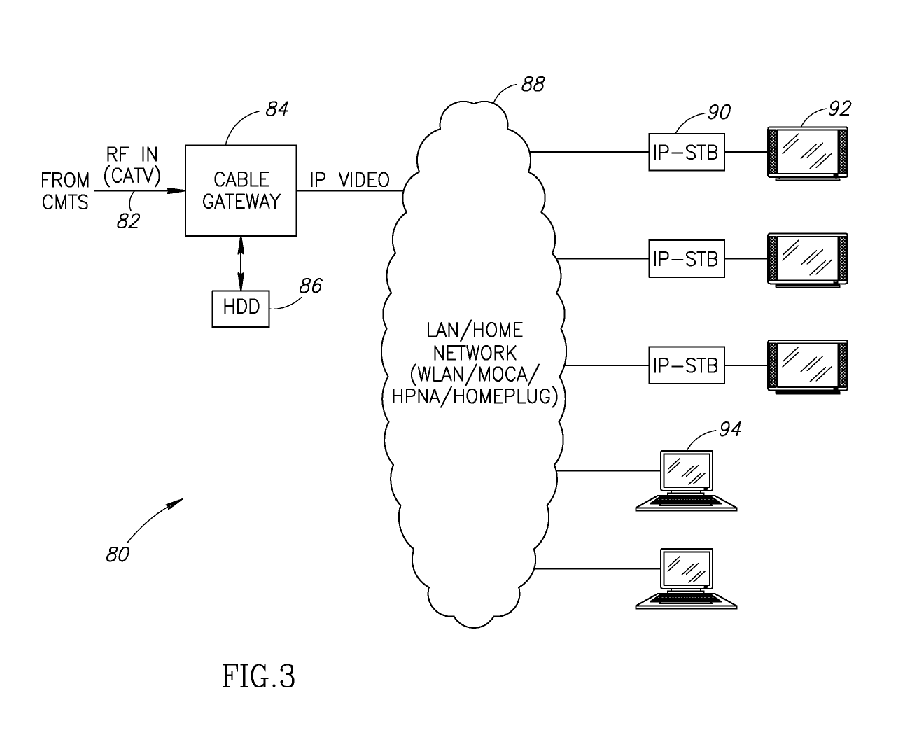

A block diagram illustrating an example home network incorporating the cable gateway architecture of the present invention is shown in FIG. 3. The system, generally referenced 80, comprises a cable gateway device 84 connected to a CATV source 82 and to a network cloud 88. One or more IP-STBs 90 and PCs 94 are connected to the network as well. TVs 92 are connected to respective IP-STBs 90. Note that the network 88 may comprise any suitable LAN or home network. Examples include an Ethernet LAN, Wireless LAN (WLAN), Multimedia over Coax Alliance (MOCA) based network, Home Phoneline Networking Association (HPNA) based network, HomePlug based network (powerline), etc.

Since IP-STBs can be used both by cable operators and also by other operators such as Telco's that can only deliver video over IP (they do not provide legacy MPEG-TS support), they are most likely to become more common with a potential market greater than the market of cable STBs.

Thus, the invention separates the front-end functionality (i.e. receiving, demodulation, etc.) from the back-end functionality (decoding, video processing, etc.). In accordance with the invention, a cable gateway device (or home gateway device) performs the front-end functionality (including QAM receiver, tuner and broadband connection) while the back-end functionality of video decoding and display is performed by one or more standard IP-STBs connected to the cable gateway device over a network (e.g., home LAN).

In order to provide legacy video to IP-STBs, the cable gateway of the present invention captures the legacy MPEG-TS based DVB-C video and encapsulates it into packets (i.e. IP packets) for distribution over the network (e.g., Ethernet LAN) to the IP-STBs. The cable gateway distributes the original IP video received over the CATV source and the encapsulated legacy video as video over IP packets over the network.

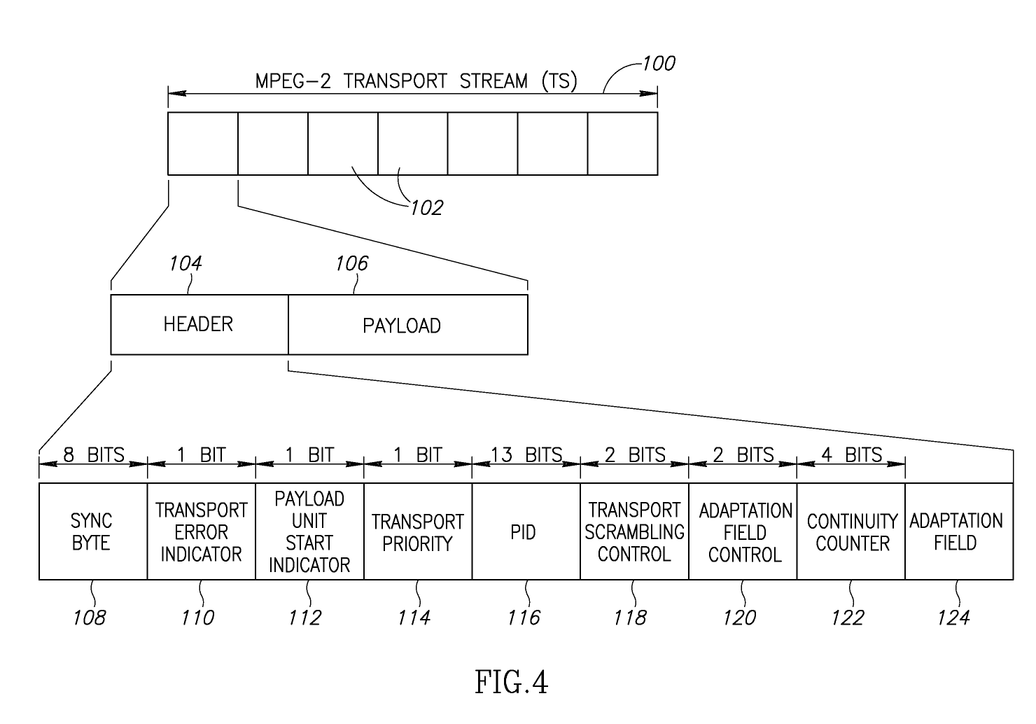

A diagram illustrating the structure of the MPEG-2 transport stream (TS) in more detail is shown in FIG. 4. The MPEG-TS stream, generally referenced 100, comprises a plurality of frames 102, each comprising a header field 104 and a payload portion 106. The header comprises a sync field 108, transport error indicator field 110, payload unit start indicator field 112, transport priority field 114, process ID (PID) 116, transport scrambling control field 118, adaptation field control field 120, continuity counter 122 and adaptation field 124.

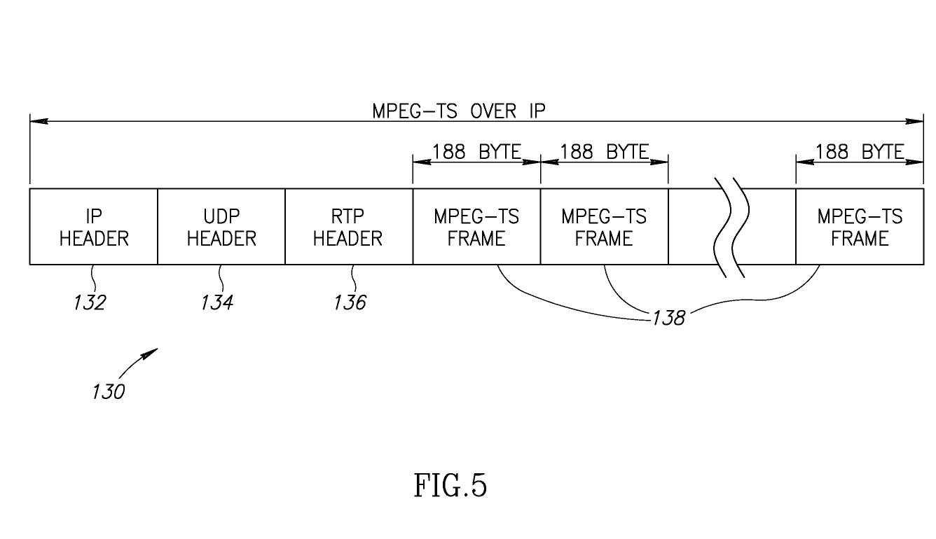

A diagram illustrating the structure of an MPEG-TS frame in more detail is shown in FIG. 5. The MPEG-TS frame is encapsulated within an IP/UDP/RTP packet, generally referenced 130. The packet 130 comprises an IP header 132, UDP header 134, RTP header 136 and a plurality of MPEG-TS frames 138.

### Cable Gateway Device

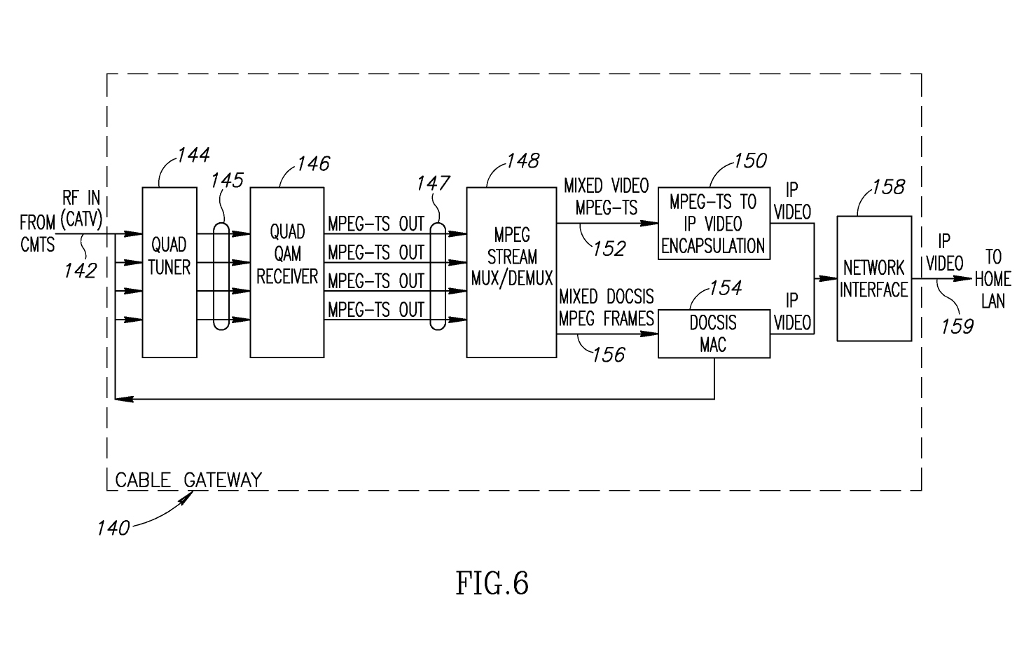

A simplified block diagram illustrating the cable gateway device of the present invention is shown in FIG. 6. The cable gateway device, generally referenced 140, comprises a quad tuner 144 adapted to receive the input RF CATV signal 142 and generate quad tuning signals 145, quad QAM receiver 146 for generating quad MPEG-TS output streams 147, MPEG stream multiplexer/demultiplexer 148, MPEG-TS to IP video encapsulator 150, DOCSIS cable modem 154 incorporating a DOCSIS MAC and a network interface (e.g., NIC) 158 for generating the IP video 159 to the one or more IP-STBs over the network.

In the example embodiment shown herein, the cable gateway device comprises a plurality of tuners and QAM receivers and an enhanced cable modem. Note that four tuners and receivers are shown for example purposes only. A DOCSIS 3.0 modem 154 (presented as an example) utilizes a technique known as channel bonding to receive a large pipe of data by receiving and demodulating two or more channels and combining the information in the one or more channels into a single large logical channel.

The multiple tuners 144 and QAM receivers 146 are used to demodulate DVB-C video channels (i.e. MPEG-TS streams), to receive a DOCSIS channel (i.e. that carries IP data) or to perform a combination of both in the event that DOCSIS and MPEG video are multiplexed on the same channel. The use of multiple tuners and receivers provides the flexibility to dynamically change both the number of legacy video channels and the number of DOCSIS channels that the device captures. Typically, the balance between the number of legacy video channels and the number of DOCSIS channels captured is set in accordance with the trade-off between the number of legacy channels versus the amount of bandwidth required for the broadband connection and the corresponding video channels transported over IP at any point of time.

A key feature of the present invention is the encapsulation (via encapsulation block 150) of the legacy MPEG-TS based DVB-C video into IP packets (or any other type of PDU). In the case of a single or multi-chip DOCSIS processor, the encapsulation is performed by the DOCSIS processor so as to capture the legacy video carried in the MPEG-TS streams and to encapsulate it in an IP packet (or IP over Ethernet packet), to resemble a video over IP stream. In the example embodiment presented herein, MPEG-TS frames are encapsulated in an IP/UDP/RTP frame that is compliant with Network Working Group RFC-2038, “RTP Payload Format for MPEG1/MPEG2 Video,” incorporated herein by reference in its entirety.

Note that the timestamp field in the RTP header is set to a timestamp that captures the relative time of arrival of the first MPEG frame in the IP datagram (e.g., a 90 kHz, 32-bit clock). The destination address of the frame comprises the address of the receiving IP-STP, with a destination port negotiated between the cable gateway and the IP-STB. In the case more than one IP-STB is to receive the same stream, the destination address may comprise a multicast group.

The encapsulation of legacy MPEG video enables the cable gateway to be connected via a network connection (such as Ethernet or any other home networking technology) to any standard IP-STB, thereby enabling the IP-STB to display both original IP video or legacy MPEG-TS based video seamlessly.

Furthermore, if there is more than one TV set in the house, only the IP-STB is duplicated for each TV. Regardless of the number of IP-STBs and TVs, only a single cable gateway device is needed. The cable gateway device can optionally comprise a hard disk drive (HDD) to implement a Digital Video Recorder (DVR) or Personal Video Recorder (PVR) for storing television programming (by storing the original MPEG frames) for distribution (as IP packets) and viewing at a later time. In this manner, the DVR functionality is also centralized.

The cable gateway system of the invention also provides conditional access support. Conditional access handling is typically one of the biggest challenges in a STB system. Conditional access techniques ensure that only authorized content can be received, displayed or copied. In a conventional STB, the conditional access is usually terminated by the video element. This ensures that the video stream remains encrypted all the way until the last point in the signal path. The architecture of the present invention provides two ways to terminate the conditional access.

A first way is to terminate the conditional access in the IP-STB. The IP-STB comprises all the necessary conditional access elements, such as a secured processor, smartcard, decryption elements, etc. The cable gateway device sends the stream out over the network in the format in which it was received (i.e. encapsulated in IP). An advantage of this scheme is that the video stream is kept in its original form until the last element in the system. A disadvantage, however, is that in a case of several IP-STBs in the home, the overhead of implementing the conditional access is duplicated at each of the IP set top boxes.

A second way is to terminate the conditional access in the cable gateway device and to distribute the decrypted video stream securely in the home using well-known DRM techniques. This makes the IP-STB generic and unaware of the conditional access scheme used by the cable or service operator and makes the system more cost effective.

In addition, the cable gateway device optionally performs transcoding of the received video before encapsulating and distributing it over the home LAN. The transcoding process is operative to change one or more aspects or parameters of the video signal. For example, the transcoding process is operative to change the video resolution in order to save bandwidth or to fit the video signal to different display devices such as large screen TVs, PDAs, cell phones, etc.

### Example Cable Gateway Device

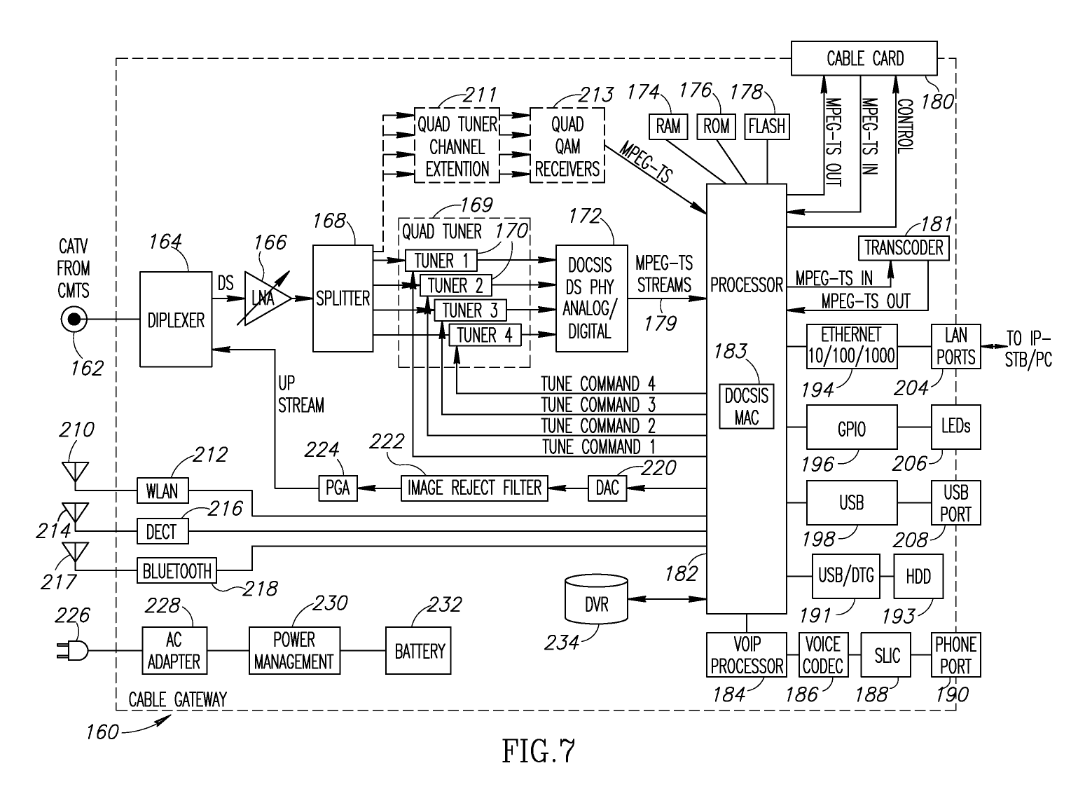

A block diagram illustrating an example cable gateway of the present invention is shown in FIG. 7. The cable modem, generally referenced 160, comprises a duplexer 164, low noise amplifier (LNA) 166, splitter 168, multiple tuner circuit 169, DOCSIS PHY circuit 172, DOCSIS compatible processor 182, DOCSIS MAC 183, VoIP processor 184, voice codec 186, subscriber line interface card (SLIC) 188, phone port 190, wireless local area network (WLAN) 212 and associated antenna 210, DECT 216 and associated antenna 214, Bluetooth 218 and associated antenna 217, Ethernet interface 194, Ethernet LAN port 204, general purpose (I/O) (GPIO) interface 196, LEDs 206, universal serial bus (USB) interface 198, USB port 208, cable card/Downloadable Conditional Access Systems (DCAS) 180, DAC 220, image reject filter 222, programmable gain amplifier (PGA) 224, AC adapter 228 coupled to mains utility power via plug 226, power management circuit 230, battery 232, RAM, 174, ROM 176 and FLASH memory 188.

Note that in the example embodiment presented herein, the cable gateway and DOCSIS enabled processor are adapted to implement the DOCSIS 3.0 standard which provides for multiple channel video reception. In addition, multiple tuner circuit 169 is presented as a quad tuner comprising four tuner sub-circuits 170 for illustration purposes only. Tuner circuits having any number of tuner sub-circuits may be constructed using the principles of the present invention. Optionally, additional tuners (e.g., quad tuners) 211 and corresponding QAM receivers 213 may be added to the gateway circuit.

In operation, the cable modem processor is the core chip set which in the example presented herein comprises a central single integrated circuit (IC) with peripheral functions added. The voice over IP (VoIP) processor 184 implements a mechanism to provide phone service outside the standard Telco channel. Chipset DSPs and codecs 196 add the functionality of POTS service for low rate voice data.

The cable modem also comprises a subscriber line interface card (SLIC) 188 which functions to provide the signals and functions of a conventional local loop to a plurality of telephone devices connected via the phone port 190 using internal 2-wire telephone wiring. In particular, it generates call progress tones including dial tone, ring tone, busy signals, etc. that are normally provided by the local loop from the CO. Since the telephone deices are not connected to the CO, the SLIC in the cable modem must provide these signals in order that the telephone devices operate correctly.

In a traditional analog telephone system, each telephone or other communication device (i.e. subscriber unit) is typically interconnected by a pair of wires (commonly referred to as tip and ring or together as subscriber lines, subscriber loop or phone lines) through equipment to a switch at a local telephone company office (central office or CO). At the CO, the tip and ring lines are interconnected to a SLIC which provides required functionality to the subscriber unit. The switches at the central offices are interconnected to provide a network of switches thereby providing communications between a local subscriber and a remote subscriber.

The SLIC is an essential part of the network interface provided to individual analog subscriber units. The functions provided by the SLIC include providing talk battery (between 5 VDC for on-hook and 48 VDC for off-hook), ring voltage (between 70-90 VAC at a frequency of 17-20 Hz), ring trip, off-hook detection, and call progress signals such as ringback, busy, and dial tone.

A SLIC passes call progress tones such as dial tone, busy tone, and ringback tone to the subscriber unit. For the convenience of the subscriber who is initiating the call, these tones normally provided by the central office give an indication of call status. When the calling subscriber lifts the handset or when the subscriber unit otherwise generates an off hook condition, the central office generates a dial tone and supplies it to the calling subscriber unit to indicate the availability of phone service. After the calling subscriber has dialed a phone number of the remote (i.e. answering) subscriber unit, the SLIC passes a ring back sound directed to the calling subscriber to indicate that the network is taking action to signal the remote subscriber, i.e. that the remote subscriber is being rung. Alternatively, if the network determines that the remote subscriber unit is engaged in another call (or is already off-hook), the network generates a busy tone directed to the calling subscriber unit.

The SLIC also acts to identify the status to, or interpret signals generated by, the analog subscriber unit. For example, the SLIC provides −48 volts on the ring line, and 0 volts on the tip line, to the subscriber unit. The analog subscriber unit provides an open circuit when in the on-hook state. In a loop start circuit, the analog subscriber unit goes off-hook by closing, or looping the tip and ring to form a complete electrical circuit. This off-hook condition is detected by the SLIC (whereupon a dial tone is provided to the subscriber). Most residential circuits are configured as loop start circuits.

Connectivity is provided by a standard 10/100/1000 Mbps Ethernet interface 194 and Ethernet LAN port 204, USB interface 198 and USB port 208 or with additional chip sets, such as wireless 802.11a/b/g via WLAN interface 212 coupled to antenna 210. In addition, a GPIO interface 196 provides an interface for LEDs 206, etc. The network connectivity functions may also include a router or Ethernet switch core. Note that the DOCSIS MAC 183 and PHY 192 may be integrated into the cable modem processor 182 or may be separate as shown in FIG. 7 wherein the DOCSIS PHY circuit 172 is shown separate from the processor 182.

In the example embodiment presented herein, the quad tuner 169 is coupled to the CATV signal from the CMTS via port 162 and is operative to convert the RF signal received over the RF cable to an IF frequency in accordance with the four tune command signals received from the processor.

The cable gateway 160 comprises a processor 182 which may comprise a digital signal processor (DSP), central processing unit (CPU), microcontroller, microprocessor, microcomputer, ASIC, FPGA core or any other suitable processing means. The cable modem also comprises static read only memory (ROM) 176, dynamic main memory 174 and FLASH memory 178 all in communication with the processor via a bus (not shown).

The magnetic or semiconductor based storage device 174 (i.e. RAM) is used for storing application programs and data. The cable gateway comprises computer readable storage medium that may include any suitable memory means, including but not limited to, magnetic storage, optical storage, semiconductor volatile or non-volatile memory, biological memory devices, or any other memory storage device.

The cable gateway also comprises a digital video recording (DVR) device 234, optional transcoder 181 and CableCard 180. The cable gateway also comprises a hard disk drive 193 in communication with the processor via USB/OTG interface.

Any software required to implement the gateway architecture mechanism of the present invention is adapted to reside on a computer readable medium, such as a magnetic disk within a disk drive unit. Alternatively, the computer readable medium may comprise a floppy disk, removable hard disk, Flash memory, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the gateway architecture of the present invention may also reside, in whole or in part, in the static or dynamic main memories or in firmware within the processor of the computer system (i.e. within microcontroller, microprocessor or microcomputer internal memory).

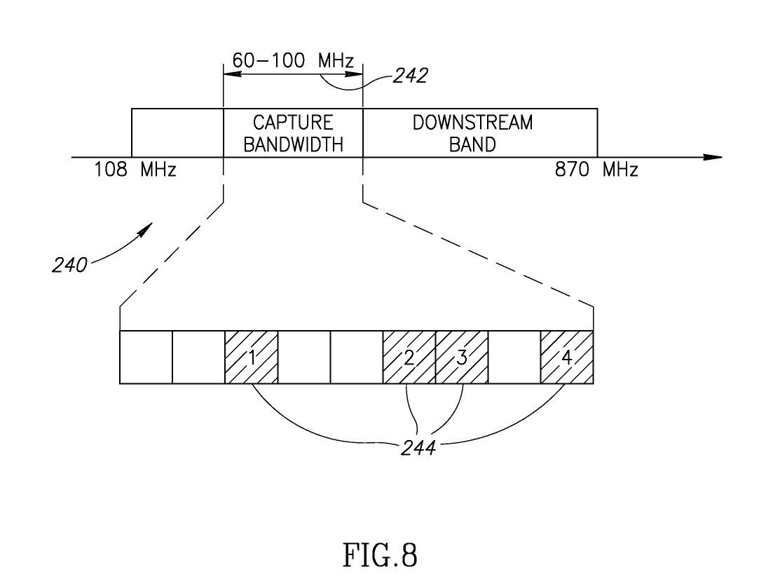

A diagram illustrating the capture bandwidth (CBW) of the downstream band received from the CMTS is shown in FIG. 8. In accordance with the DOCSIS 3.0 specification, used here for illustration purposes only, the downstream (DS) frequency band range, generally referenced 240, extends from 108 MHz to 870 MHz. The capture bandwidth 252 (defined as the sum of the tuning bands in the tuning band (TB) list) is between 60 and 100 MHz in width and may lie anywhere in the DS band. The TB is defines a single continuous frequency interval, in MHz, located anywhere in the downstream band (108 MHz to 870 MHz). The tuning band list (TB List) is defined as a list of one or more Tuning Bands supported by the cable modem that defines the cable modem tuning capabilities.

Within the capture bandwidth, are four DS channels 244 that can be located anywhere in the capture bandwidth. An example arrangement of the four DS channels is shown in FIG. 8 where the four DS channels are indicated by the crosshatched channels 244.

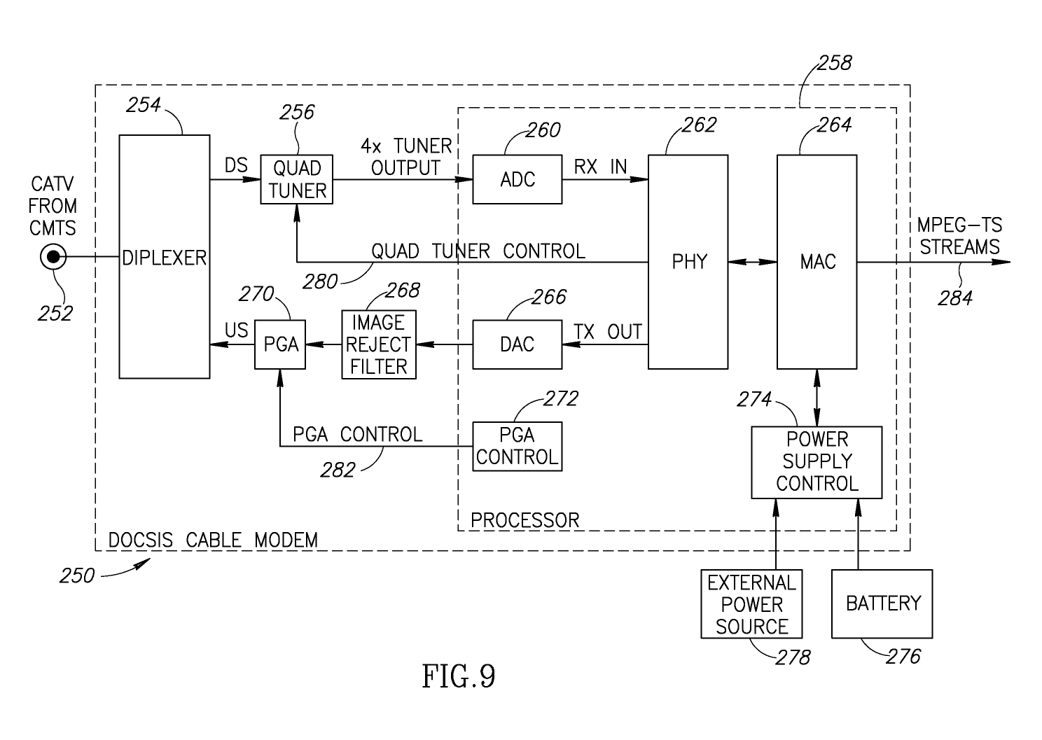

A simplified block diagram illustrating the DOCSIS processing portion of the cable gateway of FIG. 7 in more detail is shown in FIG. 9. The example DOCSIS cable modem, generally referenced 250, comprises a diplexer 254 coupled to a CATV input 252, quad tuner circuit 256, processor 258, image reject filter 268 and PGA 270. The processor 258 comprises an analog to digital converter (ADC) 260, PHY circuit 262, digital to analog converter (DAC) 266, PGA control circuit 272, power supply control 274 and MAC 264. Power is supplied by an external power source 278 e.g., utility power, etc. or a battery 276.

In operation, in the downstream (i.e. receive) direction, the receive signal from the diplexer is input to the quad tuner circuit 256. The four tuner output signals are input to the eight ADCs to provide four RX I and Q input signals to the PHY circuit. The PHY circuit provides a quad tuner control signal 280 that controls the tuning of the four tuner sub-circuits within the quad tuner. After MAC processing, one or more MPEG video streams 284 are output of the cable modem.

In the upstream (US) (i.e. transmit) direction, a digital TX output signal provided by the PHY circuit is converted to analog by the DAC. The analog signal is then filtered via the image reject filter before being amplified by the PGA whose gain is controlled by a PGA control signal 282 generated by the PGA control circuit 272.

### IP Set Top Box

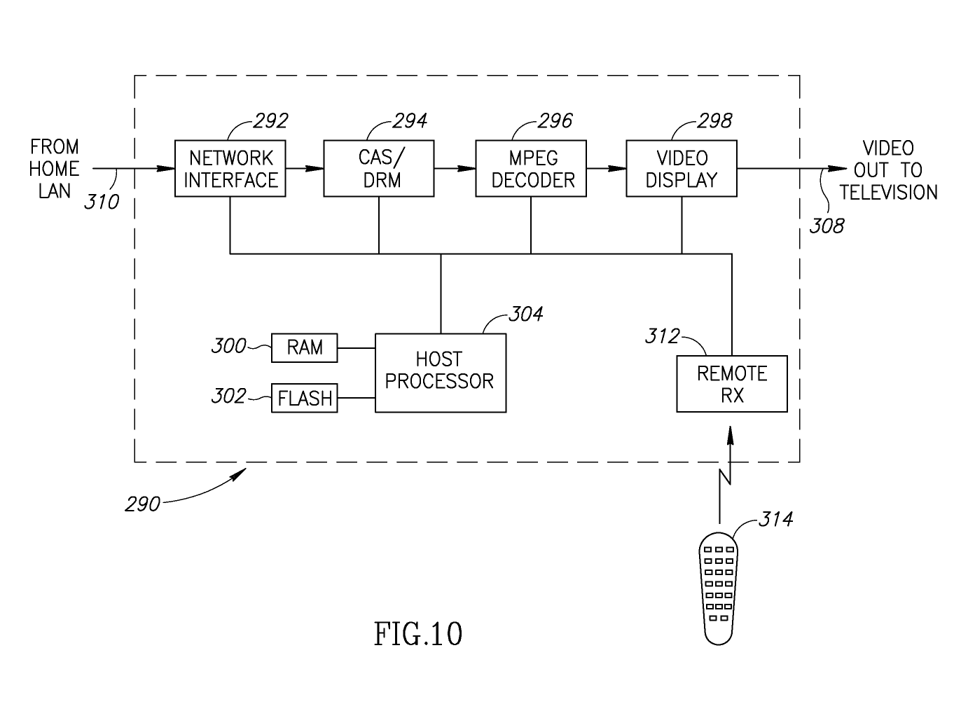

A block diagram illustrating the IP set top box of the present invention in more detail is shown in FIG. 10. The IP-STB, generally referenced 290, comprises a network interface 292 such as a LAN interface (e.g., Ethernet port, MoCA, HPNA, Powerline, WLAN, etc.) coupled to a network 11, e.g., home LAN, for receiving video over IP data 310, conditional access system (CAS) or Digital Rights Management (DRM) module 294 for decoding premium programming, an MPEG decoder 296 that decodes the video encapsulated in the IP packets, a video display module (i.e. video processor) 298 for generating the video out signal 308 for display on a end user television set (TV), a host processor 304 for executing the management software and firmware of the IP-STB including the TCP/IP stack, a Flash or other nonvolatile memory 302 for storing the application and management firmware, memory (e.g., RAM) 300 to store the run-time parameters of the software image and remote receiver 312 for receiving commands from a remote control 314 such as via infrared.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A cable gateway system, comprising:
a cable gateway device, comprising:
first receive means for receiving a legacy Digital Video Broadcasting-Cable (DVB-C) video stream from a CATV signal source;
second receive means for receiving original Internet Protocol (IP) video from said CATV source;
encapsulation means for encapsulating said legacy DVB-C video for transmission over a network;
distribution means for transmitting said original IP video and said encapsulated legacy video over said network as a video over IP stream; and
one or more IP set top boxes (STBs) connected to said network, each set top box comprising third receive means for receiving and decoding both said original IP video and said encapsulated legacy video for viewing on a video display connected thereto.

2. The system according to claim 1, wherein said encapsulation means encapsulates said legacy DVB-C video into Internet Protocol/User Datagram Protocol/Real-time Transport Protocol (IP/UDP/RTP) packets.

3. The system according to claim 1, wherein said original IP video comprises one or more Data Over Cable Service Interface Specification (DOCSIS) channels.

4. The system according to claim 1, wherein said cable gateway device comprise means for terminating conditional access therein and distributing video to said one or more IP-STBs using Digital Rights Management (DRM) techniques.

5. The system according to claim 1, wherein said distribution means transmits said video over IP stream within Ethernet frames to said one or more IP-STBs.

6. A method of video distribution, said method comprising the steps of:
receiving legacy Digital Video Broadcasting-Cable (DVB-C) video from a CATV signal source;
encapsulating said legacy video into a plurality of packets for transmission over a network;
receiving an original Internet Protocol (IP) video stream over said CATV source; and
distributing said legacy video packets and said original IP video as a video over IP stream over said network to one or more IP set top boxes connected thereto.

7. The method according to claim 6, wherein original IP video is received over one or more Data Over Cable Service Interface Specification (DOCSIS) channels.

8. The method according to claim 6, further comprising terminating conditional access and distributing video to said one or more IP-STBs using Digital Rights Management (DRM) techniques.

9. The method according to claim 6, further comprising the step of providing digital video recording (DVR) whereby said legacy video and said original IP video is recorded by a user for playback over said network at a later time.

10. A cable gateway device coupled to a network, comprising:
a plurality of receivers, each said receiver operative to receive legacy Motion Picture Experts Group-Transport Stream (MPEG-TS) based Digital Video Broadcasting-Cable (DVB-C) video channels and original Internet Protocol (IP) video over Data Over Cable Service Interface Specification (DOCSIS) channels;
means for encapsulating said legacy video into IP packets; and
a transmitter operative to transmit said original DOCSIS IP video channels and said MPEG-TS legacy video as a video over IP stream to one or more IP set top boxes (STBs) connected to said network.

11. The device according to claim 10, further comprising means for terminating conditional access and distributing video to said one or more IP-STBs using Digital Rights Management (DRM) techniques.

12. The device according to claim 10, wherein said legacy video is encapsulated into Internet Protocol/User Datagram Protocol/Real-time Transport Protocol (IP/UDP/RTP) packets transported via Ethernet frames over said network.

13. The device according to claim 10, further comprising means for dynamically changing the number of legacy video channels and the number of DOCSIS channels handled by said plurality of receivers in accordance with bandwidth requirements.

14. The device according to claim 10, further comprising a digital video recorder (DVR) wherein said legacy video and said original IP video is recorded by a user for playback over said network at a later time.

15. The device according to claim 10, further comprising means for transcoding the received video before encapsulation and transmission as a video over IP stream over said network.

16. A cable gateway connected to a CATV signal source and a local area network (LAN), comprising:
first means for receiving legacy Motion Picture Experts Group-Transport Stream (MPEG-TS) based Digital Video Broadcasting-Cable (DVB-C) video from said CATV signal source;
second means for receiving original Internet Protocol (IP) video Data Over Cable Service Interface Specification (DOCSIS) channels;
means for encapsulating said legacy video; and
means for distributing said original IP video and said encapsulated legacy video as a video over IP stream to one or more IP set top boxes connected to said network.

17. The cable gateway according to claim 16, wherein said legacy video is encapsulated into Internet Protocol/User Datagram Protocol/Real-time Transport Protocol (IP/UDP/RTP) packets transported via Ethernet frames over said network.

18. The cable gateway according to claim 16, further comprising a digital video recorder (DVR) wherein said legacy video and said original IP video is recorded by a user for playback over said network at a later time.

19. The cable gateway according to claim 16, comprising means for dynamically changing the number of legacy video channels and the number of DOCSIS channels handled by said first and second receivers in accordance with bandwidth requirements.

20. The cable gateway according to claim 16, further comprising means for terminating conditional access and distributing resultant decrypted video to said one or more IP-STBs using Digital Rights Management (DRM) techniques.

21. A cable gateway connected to a network, comprising:
a plurality of tuners, each adapted to receive a CATV signal source;
a plurality of receivers, each receiver associated with one of said tuners and operative to receive legacy Motion Picture Experts Group-Transport Stream (MPEG-TS) based Digital Video Broadcasting-Cable (DVB-C) video channels and original Internet Protocol (IP) video over Data Over Cable Service Interface Specification (DOCSIS) channels;
a DOCSIS cable modem, said cable modem comprising:
means for capturing and encapsulating said legacy MPEG-TS video into IP packets for distribution to one or more IP set top boxes (STBs);
a DOCSIS media access control (MAC) operative to receive said DOCSIS MPEG frames and to generate an IP video stream therefrom;
distribution means for transmitting said legacy MPEG-TS video IP packets and said IP video stream as an IP over video stream to said one or more IP-STBs over said network.

22. The cable gateway according to claim 21, wherein said cable modem comprises means for assigning each receiver to either a DOCSIS channel bonding group or to a legacy video channel.

23. The cable gateway according to claim 21, wherein said cable modem comprises means for terminating conditional access and distributing video to said one or more IP-STBs using Digital Rights Management (DRM) techniques.

24. The cable gateway according to claim 21, wherein said DOCSIS cable modem comprises a transcoder for transcoding said IP video before encapsulation and transmission over said network.

25. The cable gateway according to claim 21, further comprising a digital video recorder (DVR) wherein said legacy video and said original IP video are recorded by a user for playback over said network at a later time.
